(19) United States
(12) Patent Application Publication
(10) Pub. No.: US 2023/0370551 A1
(43) Pub. Date: Nov. 16, 2023

(54) PROCESSING SYSTEM, TERMINAL DEVICE, AND PROCESSING METHOD

(71) Applicant: SHARP KABUSHIKI KAISHA, Sakai City (JP)

(72) Inventor: CHIKARA MATSUDA, Sakai City (JP)

(21) Appl. No.: 18/144,764

(22) Filed: May 8, 2023

(30) Foreign Application Priority Data
May 16, 2022 (JP) 2022-080304

(51) Int. Cl. H04N 1/00

(52) U.S. Cl. CPC H04N 1/00074; H04N 1/00037; H04N 1/00464

(57) ABSTRACT

A processing system includes a job outputter, a processor, a first display, and a second display. The job outputter outputs a job from a terminal device to a processing apparatus. The processor processes the job in the processing apparatus. The first display displays, in accordance with a notification based on the processing of the job, a procedure corresponding to the notification on the terminal device. The second display displays a setting screen corresponding to the procedure on the processing apparatus.

### BACKGROUND OF THE INVENTION

### Field of the Invention

The present disclosure relates to a processing system and the like.

### Description of the Background Art

Some image processing apparatuses that are controlled by a terminal device are capable of processing jobs outputted from the terminal device. In a case where a necessary setting for job processing in an image processing apparatus is not properly configured and causes a failure in the job processing, for example, the conventional art approach at best is to display an error message, such as “Failed to use. Review settings of XX”, providing no specific measures for solving the cause of the job processing failure.

In view of such circumstances, for example, a conventionally known information processing system is configured to refer to the currently configured settings displayed on an operation screen of a multifunction peripheral/printer (MFP) and configured MFP settings preliminarily held in a mobile terminal. Based on these configured settings, the known information processing system diagnoses information on items such as those that need to be reviewed and those that need to be set with respect to the MFP settings, and displays the diagnosis results on an operation screen of the mobile terminal.

However, this conventionally known technology helps, for example, identify a cause of a failure in job processing such as printing, but does not directly help solve the cause of the job processing failure. Furthermore, as image processing apparatuses are becoming increasingly sophisticated, more complex job settings are possible in such apparatuses. An operation screen for receiving job settings tends to adopt a hierarchical structure in order to make effective use of a limited display area. In a case where a job processing failure is caused by a setting in a lower layer, therefore, it is difficult to identify the cause contributing to the job processing failure at a glance.

An objective of the present disclosure is to provide a processing system and the like that makes it easy to identify a cause contributing to a job processing failure and that makes it possible to solve the cause of the job processing failure without creating a burden on a user.

### SUMMARY OF THE INVENTION

In order to solve the problem described above, a processing system according to an aspect of the present disclosure includes: a job outputter that outputs a job from a terminal device to a processing apparatus; a processor that processes the job in the processing apparatus; a first display that displays, in accordance with a notification based on the processing of the job, a procedure corresponding to the notification on the terminal device; and a second display that displays a setting screen corresponding to the procedure on the processing apparatus.

A terminal device according to another aspect of the present disclosure includes: a controller capable of outputting a job to a processing apparatus; and a display that displays, in accordance with a notification based on processing of the job in the processing apparatus, a procedure corresponding to the notification, wherein the controller outputs, to the processing apparatus, a display instruction to display a setting screen corresponding to the procedure.

A processing method according to another aspect of the present disclosure includes: outputting a job from a terminal device to a processing apparatus; processing the job in the processing apparatus; displaying, in accordance with a notification based on the processing of the job, a procedure corresponding to the notification on the terminal device; and displaying a setting screen corresponding to the procedure on the processing apparatus.

The present disclosure provides a processing system and the like that makes it easy to identify a cause contributing to a job processing failure and that makes it possible to solve the cause of the job processing failure without creating a burden on a user.

### BRIEF DESCRIPTION OF THE DRAWINGS

FIG. 1 is a diagram schematically illustrating an overall configuration of a processing system according to a first embodiment.

FIG. 2 is a functional configuration diagram of a terminal device according to the first embodiment.

FIG. 3 is a diagram illustrating a guidance determination table.

FIG. 4 is a functional configuration diagram of a multifunction peripheral according to the first embodiment.

FIG. 5 is a diagram illustrating an error information table.

FIG. 6 is a diagram for explaining a flow of processing according to the first embodiment.

FIG. 7 is a diagram for explaining a flow of processing according to the first embodiment.

FIG. 8 is a diagram for explaining a flow of processing according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIGS. 15A and 15B are each a diagram for explaining an operation example according to a second embodiment.

FIG. 16 is a functional configuration diagram of a terminal device according to a third embodiment.

FIG. 17 is a diagram for explaining a flow of processing according to the third embodiment.

FIG. 18 is a functional configuration diagram of a multifunction peripheral according to a fourth embodiment.

FIG. 19 is a diagram for explaining a flow of processing according to the fourth embodiment.

FIG. 20 is a diagram for explaining a flow of processing according to the fourth embodiment.

FIG. 21 is a diagram for explaining an operation example according to the fourth embodiment.

### DESCRIPTION OF THE PREFERRED EMBODIMENTS

The following describes embodiments of the present disclosure with reference to the accompanying drawings. In the present disclosure, a multifunction peripheral 50 that can process jobs in operation modes such as copy, scan, fax, and e-mail transmission modes is described as a configuration example of a processing apparatus. Note that the following embodiments are merely examples for describing the present disclosure, and the technical scope of the disclosure set forth in the claims is not limited to the description given below.

### 1. First Embodiment

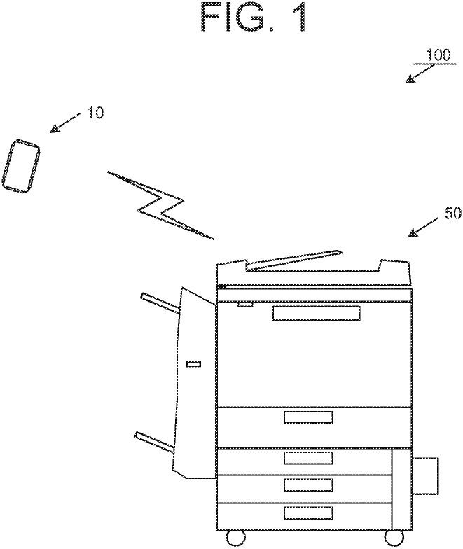

FIG. 1 is a diagram schematically illustrating an overall configuration of a processing system 100 according to a first embodiment. The processing system 100 includes a terminal device 10 and the multifunction peripheral 50.

The terminal device 10 is communicatively connected to the multifunction peripheral 50. The terminal device 10 is configured to output a job to the multifunction peripheral 50 and to be able to obtain error information as a notification from the multifunction peripheral 50.

Note here that the term “error information” according to the present disclosure means information on an error or an event that has caused a failure, if any, in job processing by the multifunction peripheral 50. The multifunction peripheral 50 according to the present disclosure can store the error information and output, for example, characters and numbers obtained by partially or entirely encoding the error information to the terminal device 10 as an error code.

### 1.1 Functional Configuration

### 1.1.1 Terminal Device 10

The terminal device 10 according to the present disclosure may be, for example, configured as a so-called mobile terminal device, such as a smartphone, a cellular phone, a tablet, or a laptop computer. The terminal device 10 is configured as a device that has at least functionality for providing a (graphical) user interface, functionality for communication, and functionality specific to the mobile terminal device.

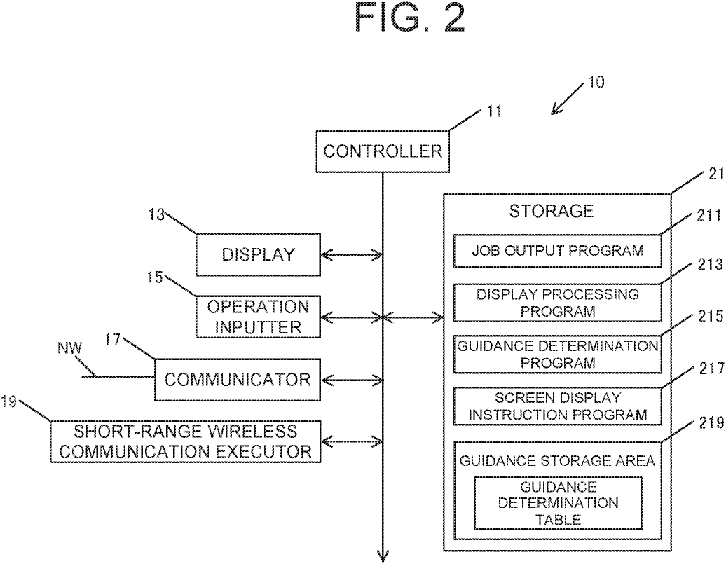

FIG. 2 is a functional configuration diagram of the terminal device 10. The terminal device 10 includes a controller 11, a display 13, which is a first display, an operation inputter 15, a communicator 17, a short-range wireless communication executor 19, and a storage 21.

The controller 11 performs overall control of the terminal device 10. The controller 11 includes, for example, one or more computing devices (for example, central processing units (CPUs)). The controller 11 reads and executes various programs stored in the storage 21 to implement various functions thereof.

The display 13 displays various information to a user, for example. The display 13 includes, for example, a liquid crystal display (LCD) or an organic electro-luminescence (EL) display.

The operation inputter 15 receives input of information from the user, for example. The operation inputter 15 may be configured as a touch panel display that allows input via the display 13. In this case, for example, the touch panel display may adopt, as an input method thereof, a resistive method, an infrared method, an inductive method, or a capacitive method.

The communicator 17 includes either or both of a wired interface and a wireless interface to communicate with other devices such as the multifunction peripheral 50 via a network (NW) such as a local area network (LAN), a wide area network (WAN), the Internet, or a telephone line.

No particular limitations are placed on the configuration of the short-range wireless communication executor 19 as long as the short-range wireless communication executor 19 can use a short-range wireless communication protocol such as Wi-Fi (registered trademark), Bluetooth (registered trademark), infrared, near field communication (NFC), or radio frequency identification (RFID), and can communicate with other devices such as the multifunction peripheral 50. Note that the terminal device 10 may have a configuration in which the communicator 17 bears the function of the short-range wireless communication executor 19.

The storage 21 stores therein various programs necessary for operation of the terminal device 10 and various types of data. The storage 21 may include, for example, storage devices such as random access memory (RAM), a hard disk drive (HDD), a solid-state drive (SSD), and read only memory (ROM).

In the first embodiment, the storage 21 stores therein a job output program 211, a display processing program 213, a guidance determination program 215, and a screen display instruction program 217. In the storage 21, a guidance storage area 219 is reserved.

The controller 11 reads the job output program 211 when outputting a job to be processed by the multifunction peripheral 50. The controller 11 that has read the job output program 211 receives setting values, commands, and other items necessary for job processing in operation modes such as copy, scan, fax, and e-mail transmission modes. The controller 11 then functions as a job outputter that outputs the settings, commands, and other items that have been received, as a job to be processed by the multifunction peripheral 50.

The controller 11 reads the display processing program 213 when displaying, on the display 13, an image such as an input screen for receiving setting values, commands, and other items related to job processing. Upon obtaining an error code from the multifunction peripheral 50, the controller 11 that has read the display processing program 213 displays guidance on the display 13 as a procedure for solving the cause of the job processing failure.

Upon obtaining an error code from the multifunction peripheral 50, the controller 11 executes the guidance determination program 215 to refer to a guidance determination table and determine guidance for solving the cause of the job processing failure.

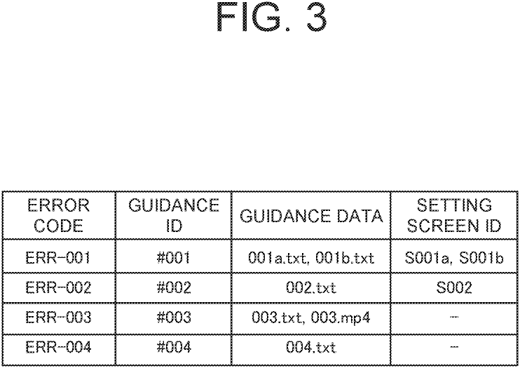

The following describes the guidance determination table with reference to FIG. 3. FIG. 3 is a diagram illustrating an example of a data structure of the guidance determination table. The guidance determination table includes guidance IDs, guidance data, and setting screen IDs associated with error codes.

These error codes correspond to error codes outputted by the multifunction peripheral 50. Each guidance ID associated with an error code is an identifier for uniquely identifying a type of guidance suitable for solving the cause of a corresponding job processing failure in the multifunction peripheral 50. The guidance data represents actual data of various types of guidance identified by the respective guidance IDs. Each setting screen ID is an identifier for identifying a setting screen to be displayed on a display 53 of the multifunction peripheral 50 based on the determined guidance. Each setting screen identified by the setting screen ID may be configured as a setting screen for solving the cause of the job processing failure and processing the job normally.

The controller 11 that has read the guidance determination program 215 is enabled to determine guidance suitable for solving the cause of the job processing failure based on the error code obtained from the multifunction peripheral 50 by referring to the guidance determination table. The controller 11 then reads the display processing program 213 to be enabled to display, on the display 13, the guidance data corresponding to the guidance ID of the determined guidance, thereby presenting suitable guidance for solving the cause of the job processing failure to the user.

Note that instead of referring to the guidance determination table, the controller 11 may alternatively determine suitable guidance by inputting, for example, an error code or error information to a prediction model generated through iterative learning.

Returning to FIG. 2, the controller 11 reads the screen display instruction program 217 when giving, to the multifunction peripheral 50, an instruction on a setting screen to be displayed. The controller 11 that has read the screen display instruction program 217 determines the setting screen to be displayed on the display 53 of the multifunction peripheral 50 by referring to the guidance determination table based on the error code obtained from the multifunction peripheral 50. Then, based on the determination result, the controller 11 gives a display instruction to display the setting screen to the multifunction peripheral 50.

The guidance determination table described above, the guidance data corresponding to the guidance ID, and other information are stored in the guidance storage area 219.

### 1.1.2 Multifunction Peripheral 50

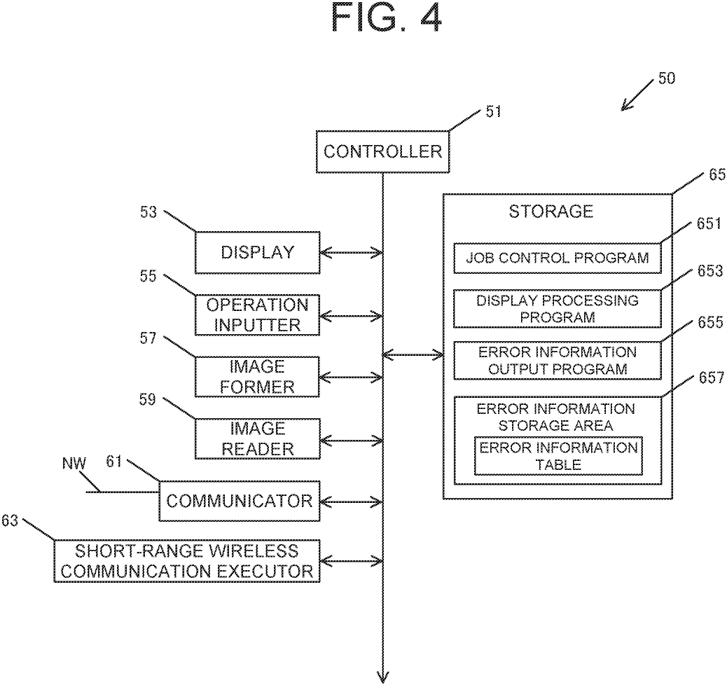

FIG. 4 is a functional configuration diagram of the multifunction peripheral 50. The multifunction peripheral 50 includes a controller 51, the display 53, which is a second display, an operation inputter 55, an image former 57, an image reader 59, a communicator 61, a short-range wireless communication executor 63, and a storage 65.

The controller 51 performs overall control of the multifunction peripheral 50. The controller 51 includes, for example, one or more computing devices (for example, CPUs)). The controller 51 reads and executes various programs stored in the storage 65 to implement various functions thereof.

The display 53 displays various information to a user, for example. The display 53 includes, for example, an LCD or an organic EL display.

The operation inputter 55 receives input of information from the user, for example. The operation inputter 55 may include, for example, hard keys (for example, numeric keypad) and buttons. Note that the operation inputter 55 may be configured as a touch panel that allows input via the display 53. In this case, for example, the touch panel may adopt, as an input method thereof, a common method such as a resistive method, an infrared method, an inductive method, or a capacitive method.

The image former 57 forms an image on paper, which is a recording medium, based on image data. The image former 57 feeds paper from a paper feeder, forms an image on the paper based on image data, and then discharges the paper to a paper discharger. The image former 57 may include, for example, an electrophotographic laser printer. In this case, the image former 57 forms images using toners supplied from toner cartridges, not shown, corresponding to respective toner colors (for example, cyan, magenta, yellow, and black).

The image reader 59 scans and reads a document image to generate image data. The image reader 59 may be, for example, configured as a scanner device including an image sensor such as a charge coupled device (CCD) or a contact image sensor (CIS). No particular limitations are placed on the configuration of the image reader 59 as long as the image reader 59 is configured to generate image data by reading a reflected light image from a document image using an image sensor.

The communicator 61 includes, for example, either or both of a wired interface and a wireless interface to communicate with other devices such as the terminal device 10 via a network (NW) such as a LAN, a WAN, the Internet, a telephone line, or a facsimile line.

No particular limitations are placed on the configuration of the short-range wireless communication executor 63 as long as the short-range wireless communication executor 63 can use a short-range wireless communication protocol such as Wi-Fi (registered trademark), Bluetooth (registered trademark), infrared, NFC, or RFID, and can communicate with other devices such as the terminal device 10. Note that the multifunction peripheral 50 may have a configuration in which the communicator 61 bears the function of the short-range wireless communication executor 63.

The storage 65 stores therein various programs necessary for operation of the multifunction peripheral 50 and various types of data. The storage 65 may include, for example, storage devices such as RAM, an HDD, an SSD, and ROM.

In the first embodiment, the storage 65 stores therein a job control program 651, a display processing program 653, and an error information output program 655. In the storage 65, an error information storage area 657 is reserved.

The controller 51 reads the job control program 651 in order to control processing in operation modes such as copy, scan, fax, and e-mail transmission modes on a per-job basis. The controller 51 that has read the job control program 651 functions as a processor that processes a job outputted from the terminal device 10.

The controller 51 reads the display processing program 653 when displaying, on the display 53, setting screens for receiving input of various setting values, execution instructions, or termination instructions related to job execution, a basic screen (for example, home screen) for displaying the setting screens in a switchable manner, a login screen for user authentication, and the like. The controller 51 that has read the display processing program 653 displays an appropriate setting screen on the display 53 based on a display instruction to display a setting screen for solving the cause of the job processing failure and processing the job normally.

The controller 51 reads the error information output program 655 when monitoring the success or failure of job processing. The controller 51 that has read the error information output program 655 monitors the success or failure of the job processing. If the job processing fails, the controller 51 refers to an error information table and outputs an error code to the terminal device 10.

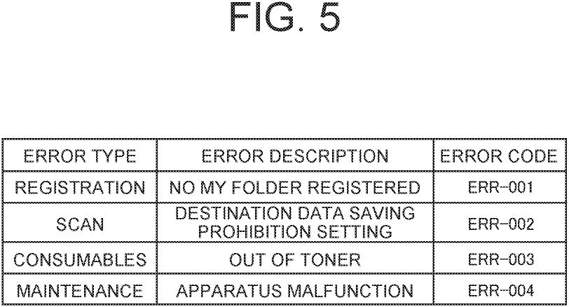

The following describes the error information table with reference to FIG. 5. FIG. 5 is a diagram illustrating an example of a data structure of the error information table. The error information table contains error codes each associated with error information including an error type and an error description.

Note here that the error types represent types by which errors that have caused job processing failures are classified, and the error descriptions represent descriptions of the errors. For example, an error code “ERR-001” is assigned to error information including an error description “No My Folder registered” classified into an error type “Registration”.

The controller 51 that has read the error information output program 655 identifies an error code according to error information (error type and error description) that has caused a job processing failure and outputs the identified error code to the terminal device 10.

The error information table is stored in the error information storage area 657.

### 1.2 Flow of Processing

### 1.2.1 Overall Processing

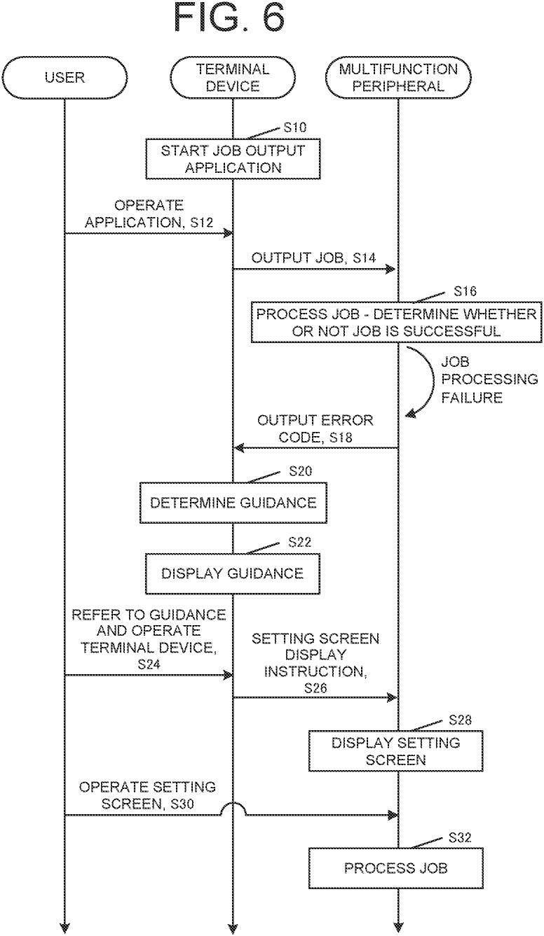

The following describes a flow of processing according to the first embodiment. FIG. 6 is a sequence diagram for explaining overall processing according to the first embodiment.

Upon receiving a job output application start instruction from the user, for example, the controller 11 of the terminal device 10 starts a job output application (Step S10).

The controller 11 displays an input screen, not shown, for receiving setting values, commands, and other items related to job processing. The user operates the application via this input screen (Step S12).

The controller 11 generates a job based on the setting values, commands, and other items that have been inputted, and outputs the job to the multifunction peripheral 50 (Step S14).

The controller 51 of the multifunction peripheral 50 obtains the job and processes the job obtained. The controller 51 then determines whether or not the job processing is successful (Step S16).

Upon determining that the job processing has failed, the controller 51 outputs, to the terminal device 10, an error code corresponding to a specific error that has caused the failure in the job processing (Step S18).

Upon obtaining the error code, the controller 11 of the terminal device 10 determines guidance based on the error code obtained (Step S20).

The controller 11 then displays guidance data corresponding to the guidance ID of the guidance determined (Step S22).

The user refers to the guidance displayed and operates the terminal device 10 (Step S24). At the same time as or after displaying the guidance data, the controller 11 determines a setting screen to be displayed on the multifunction peripheral 50 and gives, to the multifunction peripheral 50, a display instruction to display the setting screen determined (Step S26).

Upon obtaining the display instruction to display the setting screen, the controller 51 of the multifunction peripheral 50 displays the setting screen (Step S28).

The user operates the setting screen displayed on the multifunction peripheral 50 and configures appropriate settings (Step S30).

The controller 51 of the multifunction peripheral 50 processes the job based on the settings configured through the setting screen (Step S32).

### 1.2.2 Processing in Terminal Device 10

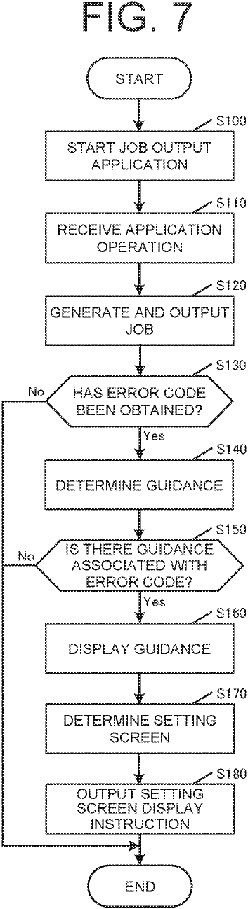

The following describes processing in the terminal device 10 with reference to a flowchart shown in FIG. 7.

The controller 11 of the terminal device 10 starts the job output application by reading the job output program 211 (Step S100).

The controller 11 then reads the display processing program 213 and displays, on the display 13, the input screen, not shown, for receiving settings, commands, and other items related to job processing.

Upon receiving the setting values, commands, and other items related to the job processing, the controller 11 generates a job based on the setting values, commands, and other items that have been received, and outputs the job to the multifunction peripheral 50 (Step S110 --> Step S120).

The controller 11 then determines whether or not an error code pertaining to a job processing failure has been obtained from the multifunction peripheral 50 (Step S130). Upon determining that an error code has been obtained from the multifunction peripheral 50, the controller 11 reads the guidance determination program 215 and determines guidance (Yes in Step S130 --> Step S140). Upon determining that no error code has been obtained, the controller 11 determines that the processing for the job outputted in Step S120 is successful and terminates the processing (No in Step S130 --> End). Note that the controller 11 may determine that the processing for the outputted job is successful and terminate the processing if the controller 11 does not obtain any error code within a predetermined period of time after outputting the job.

The controller 11 that has read the guidance determination program 215 refers to the guidance determination table illustrated in FIG. 3 to determine whether or not there is guidance associated with the error code obtained. Upon determining that there is guidance associated with the error code obtained, the controller 11 displays guidance data corresponding to the guidance (guidance ID) on the display 13 (Yes in Step S150 --> Step S160).

Upon determining that there is not guidance associated with the error code obtained, the controller 11 terminates the processing (No in Step S150 --> End). Note that in a case where the multifunction peripheral 50 or another device such as a server device, not shown, can provide the guidance, the controller 11 may alternatively obtain the guidance from the multifunction peripheral 50 or the server device, not shown, and display the guidance on the display 13.

After displaying the guidance data on the display 13, the controller 11 reads the screen display instruction program 217 and determines a setting screen (Step S170).

The controller 11 that has read the screen display instruction program 217 determines a setting screen to be displayed on the display 53 of the multifunction peripheral 50 based on the obtained error code by referring to the guidance determination table. Then, based on the determination result, the controller 11 gives a display instruction to display the setting screen to the multifunction peripheral 50 (Step S180).

### 1.2.3 Processing in Multifunction Peripheral 50

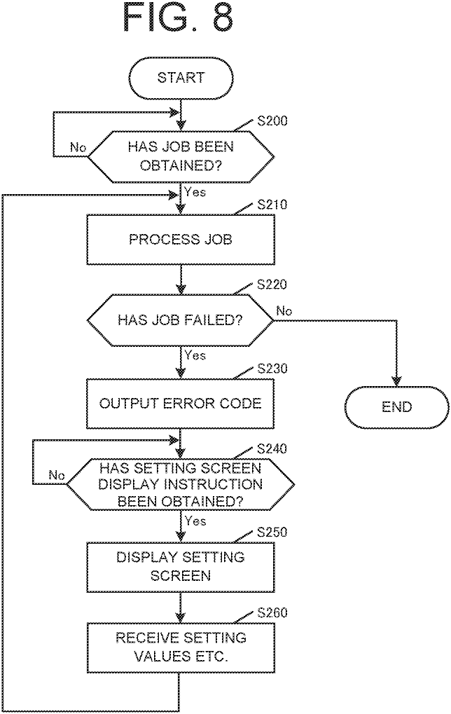

The following describes processing in the multifunction peripheral 50 with reference to a flowchart shown in FIG. 8.

The controller 51 of the multifunction peripheral 50 determines whether or not a job has been obtained from the terminal device 10 (Step S200). Upon determining that a job has been obtained from the terminal device 10, the controller 51 reads the job control program 651 and processes the job obtained (Yes in Step S200 --> Step S210). Upon determining that no job has been obtained from the terminal device 10, the controller 51 waits until a job is obtained (No in Step S200).

The controller 51 processes the job and reads the error information output program 655. The controller 51 that has read the error information output program 655 monitors the success or failure of the job processing. Upon determining that the job processing is successful, the controller 51 terminates the processing (No in Step S220 --> End).

Upon determining that the job processing has failed, the controller 51 refers to the error information table illustrated in FIG. 5, identifies an error that has caused the job processing failure, and outputs an error code assigned to the error to the terminal device 10 (Yes in Step S220 --> Step S230).

Next, the controller 51 determines whether or not a setting screen display instruction has been obtained from the terminal device 10 (Step S240). Upon determining that a setting screen display instruction has been obtained, the controller 51 reads the display processing program 653 and displays, on the display 53, a setting screen indicated by the setting screen display instruction (Yes in Step S240 --> Step S250).

Next, upon receiving setting values, commands, and other items that are appropriate for the job processing to be successful through the setting screen displayed in Step S250, the controller 51 processes the job based on the thus configured settings (Step S260 --> Step S210).

### 1.3 Operation Example

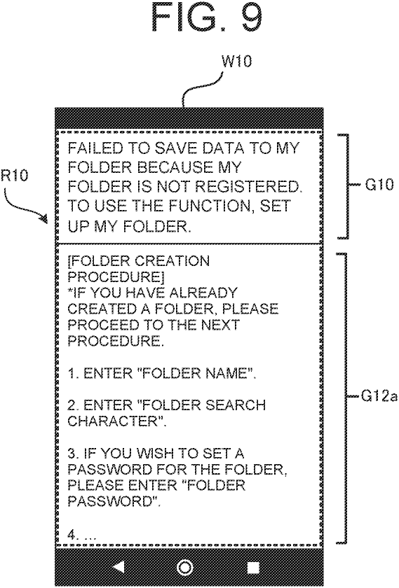

The following describes an operation example according to the first embodiment. FIG. 9 is a diagram illustrating a configuration example of a display screen W10 to be displayed by the display 13 of the terminal device 10. The display screen W10 illustrated in FIG. 9 shows an example of guidance with respect to an error shown as an example in the error information table in FIG. 5, i.e., an error that has error information including the error type “Registration” and the error description “No My Folder registered”.

Examples of jobs for which such an error can cause a job processing failure include: a job to save electronic data such as a photograph stored in the terminal device 10 into a My Folder (personal folder) provided in the multifunction peripheral 50, and a job to save image data generated through a scanning job into a My Folder. In the cases of these jobs, if a folder to save the electronic data in has not been created in the multifunction peripheral 50, or if such a folder has been created but the folder has not been associated with the user as a My Folder, the job to save electronic data such as a photograph into a My Folder or the other job cannot be executed, causing a job processing failure.

The following describes guidance data “001a.txt” identified by a guidance ID “#001”, which is shown as an example in the guidance determination table in FIG. 3, as an example of guidance to be displayed on the display 13.

The display screen W10 illustrated in FIG. 9 includes a guidance display area R10. In the guidance display area R10, guidance data corresponding to the guidance (guidance ID) determined in Step S20 in FIG. 6 or Step S140 in FIG. 7 is displayed.

The guidance display area R10 includes an error description display area G10 for displaying a cause of a job processing failure (error description) in a simple manner and an operation guidance display area G12a for providing guidance on an operation to be performed in the multifunction peripheral 50 to solve the cause of the job processing failure.

The error description display area G10 in the example shown in FIG. 9 shows that no My Folder has been registered, causing a job processing failure. The operation guidance display area G12a shows a procedure for creating a folder based on the guidance data “001a.txt”. The user using the terminal device 10 can configure settings for processing the job normally through a setting screen displayed on the multifunction peripheral 50 while referring to the error description display area G10 in the guidance display area R10 and the guidance displayed in the operation guidance display area G12a.

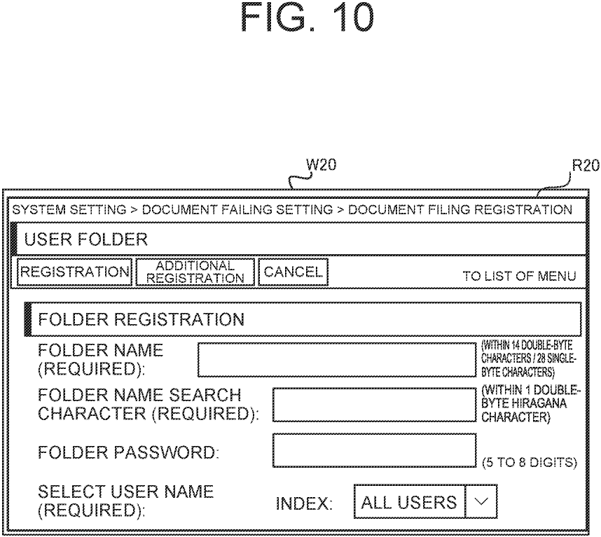

FIG. 10 is a diagram illustrating a configuration example of a setting screen W20 to be displayed by the display 53 of the multifunction peripheral 50. Referring to FIG. 10, the following describes the setting screen W20 to be displayed by the multifunction peripheral 50 upon obtaining a display instruction to display a setting screen “S001a” associated with the guidance ID “#001” shown as an example in FIG. 3.

The setting screen W20 includes a folder registration area R20. The folder registration area R20 has, for example, setting items for generating and registering a folder such as a folder name (required), a folder name search character (required), a folder password, and a user name selection (required). The user can register a folder by entering necessary information for each setting item.

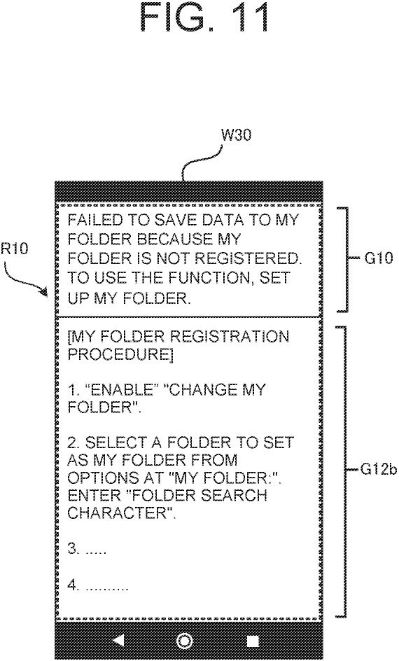

The following describes a configuration example of a display screen W30 with reference to FIG. 11. After a folder (My Folder) has been created through the display screen W10, the display screen W30 provides guidance on a procedure for associating the created folder with user information as a My Folder. Like the display screen W10, the display screen W30 includes a guidance display area R10.

An error description display area G10 shown as an example in FIG. 11 shows that no My Folder has been registered, causing a job processing failure. An operation guidance display area G12b shows the procedure for associating the created folder with user information as a My Folder based on guidance data “001b.txt”. The user using the terminal device 10 can configure settings for processing the job normally through a setting screen displayed on the multifunction peripheral 50 while referring to the error description display area G10 displayed in the guidance display area R10 and the guidance displayed in the operation guidance display area G12b.

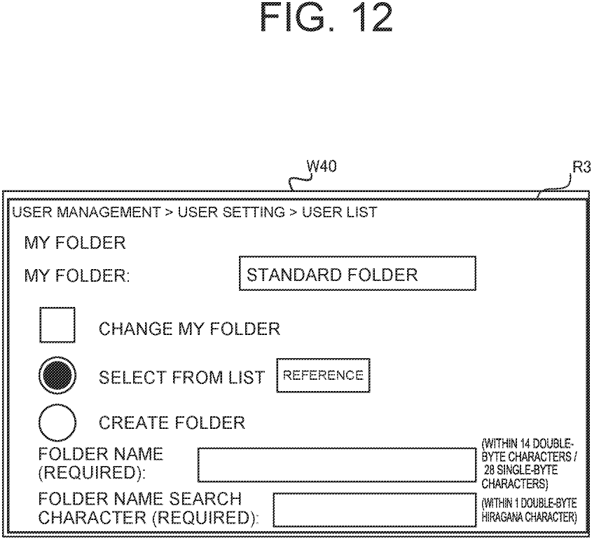

FIG. 12 is a diagram illustrating a configuration example of a setting screen W40 to be displayed by the display 53 of the multifunction peripheral 50. Referring to FIG. 12, the following describes the setting screen W40 to be displayed by the multifunction peripheral 50 upon obtaining a display instruction to display a setting screen “S001b” associated with the guidance ID “#001” shown as an example in FIG. 3.

The setting screen W40 includes a My Folder registration area R30. The My Folder registration area R30 has, for example, setting items such as a check box for receiving an instruction to change My Folders and radio buttons for receiving selection of a folder to be registered as a My Folder from a list. The user can associate a My Folder with his/her user information by making a necessary entry or selection for each setting item.

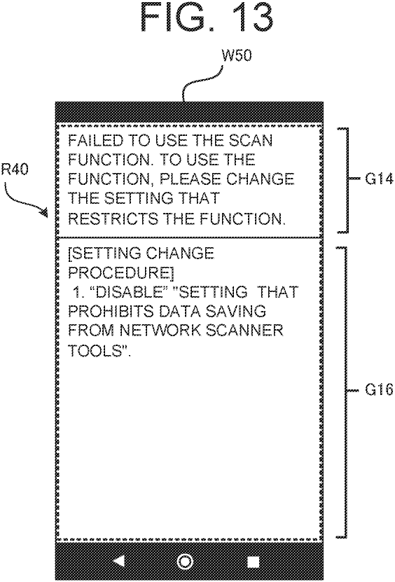

FIG. 13 is a diagram illustrating a configuration example of another display screen W50 to be displayed by the display 13 of the terminal device 10. Note that the display screen W50 illustrated in FIG. 13 shows an example of guidance with respect to an error that has error information including an error type “Scan” and an error description “Destination data saving prohibition setting” shown as an example in the error information table in FIG. 5.

Examples of jobs for which such an error can cause a job processing failure include a scan job via a network. In the case of this job, for example, if a setting to prohibit data saving from network scanners is “Enabled”, image data generated by a network scanner cannot be saved into the multifunction peripheral 50, causing a job processing failure.

The following describes guidance data “002.txt” identified by a guidance ID “#002”, which is shown as an example in the guidance determination table in FIG. 3, as guidance to be displayed on the display 13.

The display screen W50 illustrated in FIG. 13 includes a guidance display area R40. In the guidance display area R40, guidance data corresponding to the guidance (guidance ID) determined in Step S20 in FIG. 6 or Step S140 in FIG. 7 is displayed.

The guidance display area R40 includes an error description display area G14 for displaying a cause of a job processing failure (error description) in a simple manner and an operation guidance display area G16 for providing guidance on an operation to be performed in the multifunction peripheral 50 to solve the cause of the job processing failure.

The error description display area G14 in the example shown in FIG. 13 shows that a setting to restrict a function of a scan job via a network is “Enabled”, causing a job processing failure. The operation guidance display area G16 shows a procedure for disabling the prohibition setting based on the guidance data “002.txt”. The user using the terminal device 10 can configure settings for processing the job normally through a setting screen displayed on the multifunction peripheral 50 while referring to the error description display area G14 in the guidance display area R40 and the guidance displayed in the operation guidance display area G16.

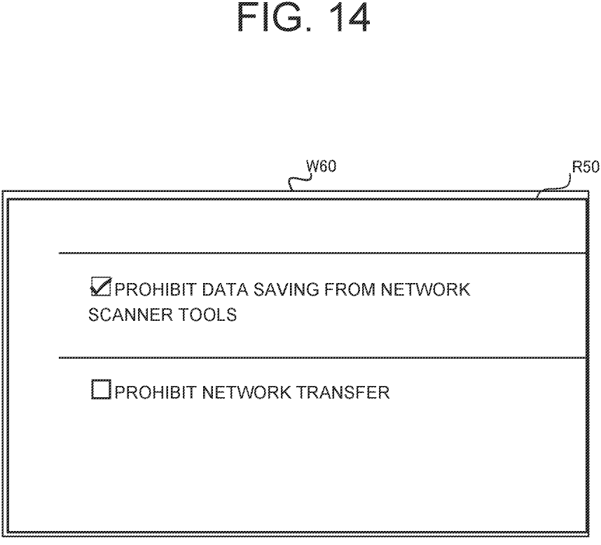

FIG. 14 is a diagram illustrating a configuration example of a setting screen W60 to be displayed by the display 53 of the multifunction peripheral 50. Referring to FIG. 14, the following describes the setting screen W60 to be displayed by the multifunction peripheral 50 upon obtaining a display instruction to display a setting screen “S002” associated with the guidance ID “#002” in the guidance determination table shown as an example in FIG. 3.

The setting screen W60 includes a network setting area R50. The network setting area R50 includes, for example, check boxes for receiving selection of network-related prohibition settings such as prohibition of data saving from network scanner tools and prohibition of network transfer. The user can disable the prohibition of data saving from network scanner tools by removing a check from the checkbox given to this prohibition setting.

As described above, according to the first embodiment, a cause contributing to a job processing failure and guidance for solving the cause of the failure are displayed, and thus the user can configure settings for processing the job normally through a setting screen while referring to the guidance. As such, the first embodiment makes it easy to identify a cause contributing to a job processing failure and makes it possible to solve the cause of the job processing failure without creating a burden on a user.

### 2. Second Embodiment

According to the first embodiment, the terminal device 10 outputs a display instruction to display a setting screen to be displayed on the display 53 of the multifunction peripheral 50 based on an error code obtained. A second embodiment is directed to a processing system that allows a user to make job processing successful without the need to enter setting values, commands, or other items through a setting screen displayed on a multifunction peripheral 50.

### 2.1 Functional Configuration

The processing system according to the second embodiment may have the same configuration as the processing system 100 according to the first embodiment. Elements of configuration of a terminal device and a multifunction peripheral in the second embodiment are therefore labeled with the same reference signs as in the first embodiment, and description thereof will be omitted herein.

### 2.2 Flow of Processing

Overall processing according to the second embodiment may be implemented by omitting the processes in Steps S26 to S30 from the flow of the overall processing described with reference to the flowchart in FIG. 6. In this case, the processes in Steps S170 and S180 in FIG. 7 to be performed by the terminal device 10 and the processes in Steps S240 to S260 in FIG. 8 to be performed by the multifunction peripheral 50 may also be omitted.

### 2.3 Operation Example

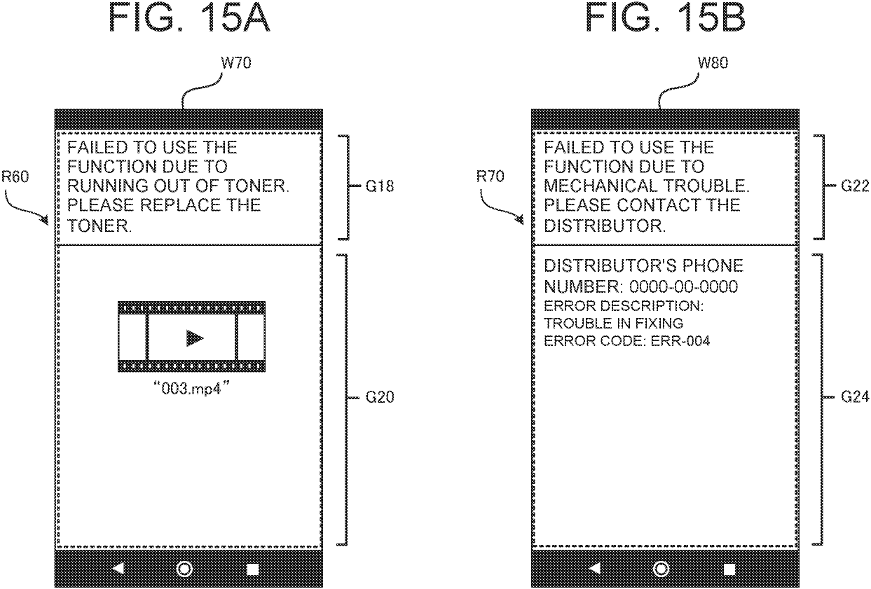

FIG. 15A is a diagram illustrating a configuration example of a display screen W70 to be displayed by a display 13 of the terminal device 10. The display screen W70 illustrated in FIG. 15A shows an example of guidance with respect to an error (information) that has error information including an error type “Consumables” and an error description “Out of Toner” shown as an example in the error information table in FIG. 5.

The following describes guidance data “003.txt” and “003.mp4” identified by the guidance ID “#003”, which is shown as an example in the guidance determination table in FIG. 3, as guidance to be displayed on the display 13.

The display screen W70 in FIG. 15A includes a guidance display area R60. The guidance display area R60 includes an error description display area G18 for displaying a cause of a job processing failure (error description) in a simple manner and an operation guidance display area G20 for providing guidance on an operation to be performed in the multifunction peripheral 50 to solve the cause of the job processing failure.

The error description display area G18 in the example shown in FIG. 15A shows that the multifunction peripheral 50 is out of toner, causing a job processing failure. A video file “003.mp4” that explains a procedure for toner replacement is attached to the operation guidance display area G20 so that the user can view the video by, for example, tapping the video file. The user using the terminal device 10 can complete the toner replacement in the multifunction peripheral 50 by referring to the error description display area G18 in the guidance display area R60 and viewing the content of the video file on the operation guidance display area G20. Note that the procedure for toner replacement is not limited to being provided in the form of a video file, and may alternatively be provided, for example, in the form of audio data or a still image. The video file does not have to be directly attached to the operation guidance display area G20. Instead, the operation guidance display area G20 may show hyperlink destination information indicating the location where the video file is stored.

FIG. 15B is a diagram illustrating a configuration example of a display screen W80 to be displayed by the display 13 of the terminal device 10. The display screen W80 illustrated in FIG. 15B is an example of guidance with respect to an error that has error information including an error type “Maintenance” and an error description “Apparatus Malfunction” shown as an example in the error information table in FIG. 5.

The following describes guidance data “004.txt” identified by a guidance ID “#004”, which is shown as an example in the guidance determination table in FIG. 3, as guidance to be displayed on the display 13.

The display screen W80 in FIG. 15B includes a guidance display area R70. The guidance display area R70 includes an error description display area G22 for displaying a cause of a job processing failure (error description) in a simple manner and an operation guidance display area G24 for providing guidance on an operation to be performed to solve the cause of the job processing failure.

The error description display area G22 in the example shown in FIG. 15B shows that the multifunction peripheral 50 has a mechanical trouble, causing a job processing failure. The operation guidance display area G24 shows information for inquiries to service personnel (call center) corresponding to the apparatus malfunction. The user using the terminal device 10 can solve the apparatus malfunction by referring to the error description display area G22 in the guidance display area R70 and reaching the contact displayed on the operation guidance display area G24.

As described above, the second embodiment has an effect of enabling the user to make job processing successful without the need to enter setting values, commands, or other items through a setting screen displayed on the multifunction peripheral, in addition to the effects of the first embodiment.

### 3. Third Embodiment

A third embodiment is directed to a processing system in which even when a display instruction to display a setting screen on a multifunction peripheral 50 is to be outputted, the outputting of the display instruction is restricted if the multifunction peripheral 50 is not located within a specific distance range.

### 3.1 Functional Configuration

### 3.1.1 Terminal Device 70

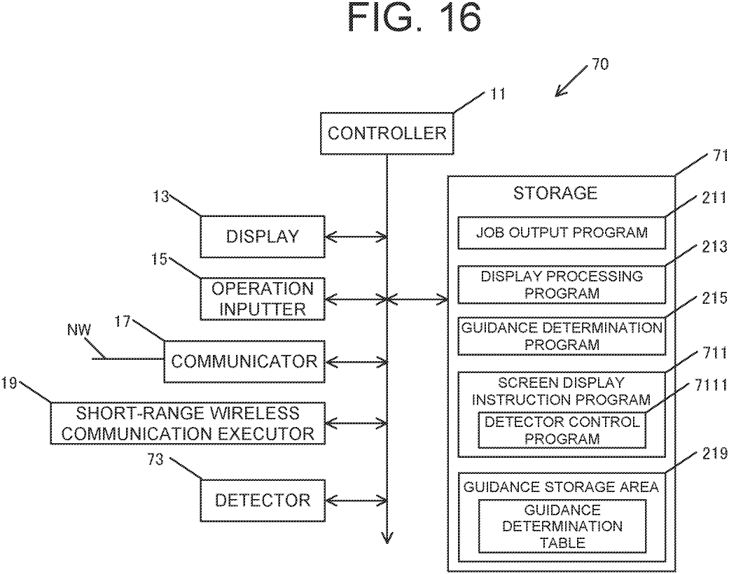

FIG. 16 is a functional configuration diagram of a terminal device 70 according to the third embodiment. The terminal device 70 includes a detector 73 in addition to the configuration of the terminal device 10 according to the first embodiment. The terminal device 70 also includes a storage 71 instead of the storage 21 of the terminal device 10 according to the first embodiment. Note that the same elements of configuration as those of the terminal device 10 are labeled with the same reference signs as in the first embodiment, and description thereof will be omitted.

The terminal device 70 includes a controller 11, a display 13, an operation inputter 15, a communicator 17, a short-range wireless communication executor 19, the detector 73, and the storage 71.

The detector 73 detects the presence or absence of a multifunction peripheral 50 and a distance to the multifunction peripheral 50. Examples of detectors usable as the detector 73 include a laser, an ultrasonic distance sensor, and a proximity sensor such as a capacitive or dielectric sensor.

The storage 71 of the third embodiment stores therein a job output program 211, a display processing program 213, a guidance determination program 215, and a screen display instruction program 711. In the storage 71, a guidance storage area 219 is reserved.

The screen display instruction program 711 includes a detector control program 7111 in addition to the configuration of the screen display instruction program 217 according to the first embodiment. The controller 11 reads the detector control program 7111 when detecting the presence or absence of the multifunction peripheral 50 and the distance to the multifunction peripheral 50. The controller 11 that has read the detector control program 7111 controls the detector 73 to obtain information on the presence or absence of the multifunction peripheral 50 and information on the distance thereto, and determines whether or not to output a screen display instruction to the multifunction peripheral 50.

### 3.1.2 Multifunction Peripheral 50

The multifunction peripheral 50 according to the third embodiment may have the same configuration as the multifunction peripheral 50 according to the first embodiment, and therefore description thereof is omitted herein.

### 3.2 Flow of Processing

### 3.2.1 Overall Processing

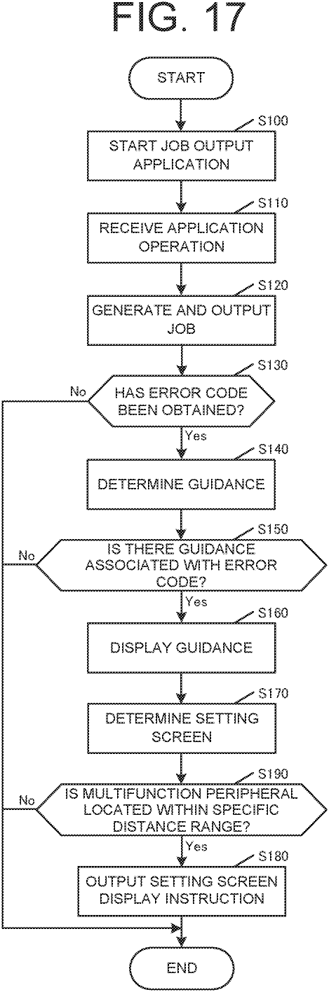

Overall processing according to the third embodiment may be performed in the same manner as the overall processing according to the first embodiment described with reference to FIG. 6. The third embodiment includes, for example, a step for detecting the presence or absence of the multifunction peripheral 50 and the distance to the multifunction peripheral 50 before the process in Step S26 in FIG. 6. The process in this step will be described with reference to FIG. 17.

### 3.2.2 Processing in Terminal Device 70

FIG. 17 is a flowchart for explaining the processing in the terminal device 70. Note that processes in Steps S100 to S170 and S180 in FIG. 17 can be performed in the same manner as those described with reference to FIG. 7, and therefore description thereof will be omitted herein.

In Step S190, the controller 11 reads the detector control program 7111. The controller 11 that has read the detector control program 7111 controls the detector 73 to obtain information on the presence or absence of the multifunction peripheral 50 and information on the distance thereto. Then, based on the information on the presence or absence of the multifunction peripheral 50 and the information on the distance thereto that have been obtained, the controller 11 determines whether or not the multifunction peripheral 50 is located within a specific distance range from the terminal device 70.

Upon determining that the multifunction peripheral 50 is located within the specific distance range from the terminal device 70, the controller 11 outputs a setting screen display instruction (Yes in Step S190 --> Step S 180). Upon determining that the multifunction peripheral 50 is not located within the specific distance range from the terminal device 70, the controller 11 restricts the outputting of the setting screen display instruction and terminates the processing (No in Step S190 --> End).

Note here that, the specific distance range may be set to a desired distance range based on the range of activities of the user using the terminal device 70, conditions of a room where the multifunction peripheral 50 is installed, and other factors. For example, in a case where a distance range within which the user can operate the multifunction peripheral 50 immediately after the multifunction peripheral 50 has displayed a setting screen is three meters or less, the controller 11 may set the specific distance range to a radius of three meters.

According to the third embodiment, if the multifunction peripheral 50 is not located within the specific distance range from the terminal device 70 being used by the user, which in other words is if the physical distance between the terminal device 70 being used by the user and the multifunction peripheral 50 is so long that the user cannot operate the multifunction peripheral 50 immediately after a setting screen display instruction is outputted, the terminal device 70 does not output the setting screen display instruction to the multifunction peripheral 50. When the user cannot operate the multifunction peripheral 50 due to such a situation and another user who is unaware of the situation operates the multifunction peripheral 50, therefore, the above-described configuration prevents an unexpected setting screen from being displayed to the other user, and thus eliminates the possibility of causing confusion about the operation of the multifunction peripheral 50.

Although Step S190 is described as a process for determining whether or not the multifunction peripheral 50 is located within the specific distance range from the terminal device 70, the controller 11 may alternatively restrict the outputting of a setting screen display instruction, for example, if the multifunction peripheral 50 is not detected by the detector 73 or if it is impossible to establish a connection through the short-range wireless communication executor 19.

As described above, if the multifunction peripheral is not located within the specific distance range from the terminal device being used by the user, the terminal device does not output a setting screen display instruction to the multifunction peripheral. Thus, the third embodiment has an effect of preventing an unexpected setting screen from being displayed to another user, and thus preventing confusion about the operation of the multifunction peripheral, in addition to the effects of the first embodiment.

### 4. Fourth Embodiment

A fourth embodiment is directed to a processing system in which guidance, which is displayed by the terminal device 10 in the first embodiment, is displayed via a web browser. The following describes the processing system according to the fourth embodiment in which a multifunction peripheral 90 provides content related to guidance to be displayed on a terminal device 10 (referred to below simply as “guidance content”). However, the processing system may be further provided with a Web server capable of providing such guidance content.

### 4.1 Functional Configuration

### 4.1.1 Terminal Device 10

The terminal device 10 according to the fourth embodiment may have the same configuration as the terminal device 10 according to the first embodiment except that, for example, the former has a Web browser that performs client control in accordance with HyperText Transfer Protocol (HTTP). Description thereof will therefore be omitted herein.

### 4.1.2 Multifunction Peripheral 90

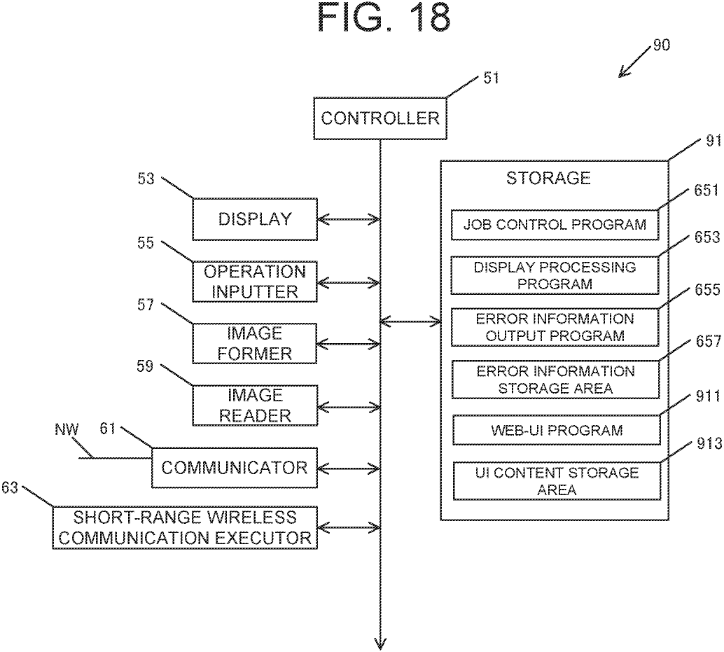

FIG. 18 is a functional configuration diagram of the multifunction peripheral 90 according to the fourth embodiment. The multifunction peripheral 90 includes a storage 91 instead of the storage 65 of the multifunction peripheral 50 according to the first embodiment. Note that the same elements of configuration as those of the multifunction peripheral 50 are labeled with the same reference signs as in the first embodiment, and description thereof will be omitted.

The multifunction peripheral 90 includes a controller 51, a display 53, an operation inputter 55, an image former 57, an image reader 59, a communicator 61, a short-range wireless communication executor 63, and the storage 91.

The storage 91 of the fourth embodiment stores therein a job control program 651, a display processing program 653, an error information output program 655, and a Web-UI program 911. In the storage 91, an error information storage area 657 and a UI content storage area 913 are reserved.

The controller 51 reads the Web-UI program 911 when providing guidance content to the Web browser of the terminal device 10. The Web-UI program 911 functions as a Web application, including programs such as a session management program for managing a session with the Web browser of the terminal device 10 and a screen control program for providing guidance content to the Web browser as image information (for example, HyperText Markup Language (HTML) data or Extensible Markup Language (XML) data) and controlling a screen of the Web browser.

The guidance content (image information) is stored in the UI content storage area 913.

### 4.2 Flow of Processing

### 4.2.1 Processing in Terminal Device 10

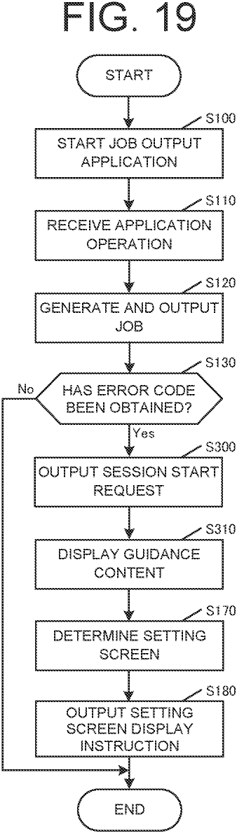

The following describes processing in the terminal device 10 with reference to FIG. 19. Processes in Steps S100 to S130, S170, and S180 in FIG. 19 can be performed in the same manner as those described with reference to FIG. 7, and therefore description thereof will be omitted herein.

Upon determining in Step S130 that an error code has been obtained from the multifunction peripheral 90, the controller 11 of the terminal device 10 adds a session start request to the header of an HTTP request message via the web browser and outputs the message to the multifunction peripheral 90 (Yes in Step S130 --> Step S 300).

Then, upon obtaining guidance content from the multifunction peripheral 90, the controller 11 displays the guidance content as a UI in the Web browser (Step S310). Note that a candidate setting screen to be displayed on the multifunction peripheral 90 may be displayed along with the guidance content in the Web browser.

### 4.2.2 Processing in Multifunction Peripheral 90

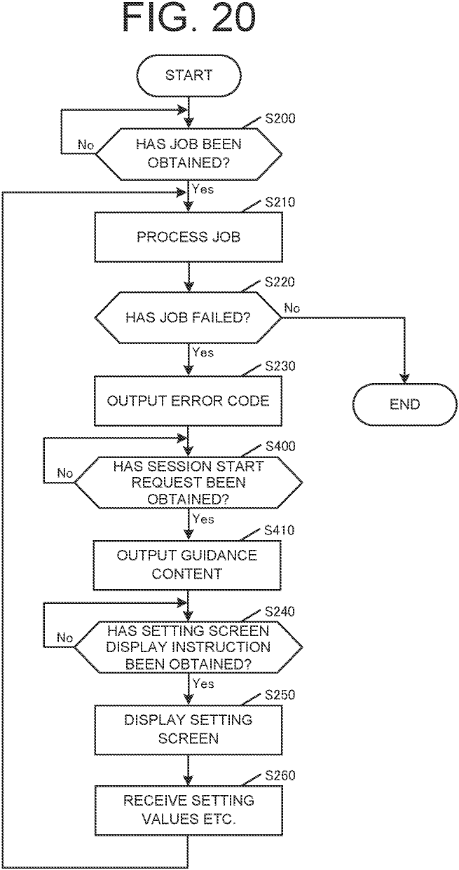

The following describes processing in the multifunction peripheral 90 with reference to FIG. 20. Processes in Steps S200 to S230 and S240 to S260 in FIG. 20 can be performed in the same manner as those described with reference to FIG. 8, and therefore description thereof will be omitted herein.

The controller 51 of the multifunction peripheral 90 determines whether or not a session start request has been obtained from the terminal device 10 (Step S400). Upon determining that a session start request has been obtained from the terminal device 10, the controller 51 starts a session with the terminal device 10 and outputs, to the terminal device 10, guidance content corresponding to an error code outputted (Yes in Step S400 --> Step S410). Upon determining that no session start request has been obtained from the terminal device 10, the controller 51 waits until a session start request is obtained (No in Step S400).

### 4.3 Operation Example

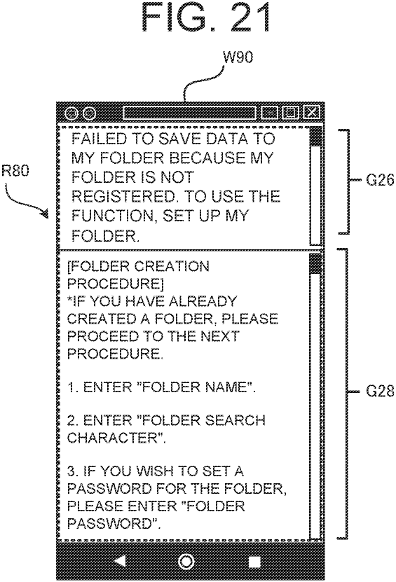

The following describes an operation example according to the fourth embodiment. FIG. 21 is a diagram illustrating a configuration example of a display screen W90 to be displayed by a display 13 of the terminal device 10 via the Web browser. The display screen W90 illustrated in FIG. 21 shows, as in the example shown in FIG. 9, an example of guidance with respect to the error shown as an example in the error information table in FIG. 5, i.e., the error that has error information including the error type “Registration” and the error description “No My Folder registered”.

The display screen W90 in FIG. 21 includes a guidance display area R80. In the guidance display area R80, guidance content outputted from the multifunction peripheral 90 is displayed.

The guidance display area R80 includes an error description display area G26 for displaying a cause of a job processing failure (error description) in a simple manner and an operation guidance display area G28 for providing guidance on an operation to be performed in the multifunction peripheral 90 to solve the cause of the job processing failure.

The error description display area G26 in the example shown in FIG. 21 shows that no My Folder has been registered, causing a job processing failure. The operation guidance display area G28 shows a procedure for creating a folder based on the guidance content. The user using the terminal device 10 can configure settings for processing the job normally through a setting screen displayed on the multifunction peripheral 90 while referring to the error description display area G26 in the guidance display area R80 and the guidance displayed in the operation guidance display area G28.

As described above, the fourth embodiment has a configuration in which the terminal device displays guidance content obtained from the multifunction peripheral in the Web browser as a UI. Thus, the fourth embodiment has an effect of eliminating the need for the terminal device to retain guidance data and enabling the terminal device to prevent storage space thereof from being unnecessarily occupied or consumed, in addition to the effects of the first embodiment.

The present disclosure is not limited to the foregoing embodiments, and various modifications may be made. That is, the technical scope of the present disclosure also includes an embodiment obtained by combining technical measures modified as appropriate without departing from the spirit of the present disclosure.

Although some parts of the foregoing embodiments are described separately for convenience of explanation, it is needless to say that such embodiments may be combined and implemented within a technically allowable range.

The program(s) that operates on each device (apparatus) in the foregoing embodiments is a program that controls the CPU or the like (program that causes a computer to function) so as to implement the functions according to the foregoing embodiments. According to the embodiments, it is assumed that each device (apparatus) simultaneously executes a plurality of programs as needed by multitask processing. Information handled by each device (apparatus) is temporarily accumulated in a temporary storage device (for example, RAM)) during processing, is then stored in various storage devices such as read only memory (ROM) and an HDD, and is read, corrected, and written by the CPU as needed.

Here, a recording medium that stores the program may be, for example, any of a semiconductor medium (for example, ROM and a non-volatile memory card), an optical recording medium/magneto-optical recording medium (for example, Digital Versatile Disc (DVD)), a Magneto Optical Disc (MO), a Mini Disc (MD), a Compact Disc (CD), and a Blu-ray (registered trademark) Disc (BD)), and a magnetic recording medium (for example, a magnetic tape and a flexible disk). Furthermore, not only are the functions of the foregoing embodiments implemented through execution of the loaded program, but the functions of the present disclosure may also be implemented through processing performed in cooperation with, for example, an operating system or other application programs on the basis of instructions of the program.

For market distribution, the program may be stored and distributed in a portable recording medium or transferred to a server computer connected via a network such as the Internet. In this case, a storage device of the server computer is obviously included in the present disclosure.

What is claimed is:

1. A processing system comprising:
a job outputter that outputs a job from a terminal device to a processing apparatus;
a processor that processes the job in the processing apparatus;
a first display that displays, in accordance with a notification based on the processing of the job, a procedure corresponding to the notification on the terminal device; and
a second display that displays a setting screen corresponding to the procedure on the processing apparatus.

2. The processing system according to claim 1, wherein
the processing apparatus outputs, as the notification, error information related to the processing of the job, and
the first display displays a procedure corresponding to the error information obtained from the processing apparatus.

3. The processing system according to claim 1, further comprising a detector that detects the processing apparatus, wherein
the second display restricts the displaying of the setting screen if the processing apparatus is not detected within a specific distance range.

4. The processing system according to claim 1, wherein the processing apparatus provides the procedure and includes a Web application for displaying the provided procedure in a Web browser.

5. A terminal device comprising:
a controller capable of outputting a job to a processing apparatus; and
a display that displays, in accordance with a notification based on processing of the job in the processing apparatus, a procedure corresponding to the notification, wherein
the controller outputs, to the processing apparatus, a display instruction to display a setting screen corresponding to the procedure.

6. A processing method comprising:
outputting a job from a terminal device to a processing apparatus;
processing the job in the processing apparatus;
displaying, in accordance with a notification based on the processing of the job, a procedure corresponding to the notification on the terminal device; and
displaying a setting screen corresponding to the procedure on the processing apparatus.
